(19) United States
(12) Patent Application Publication
(10) Pub. No.: US 2013/0305895 A1
(43) Pub. Date: Nov. 21, 2013

(54) Film Slitter for Film Wrapped Bundling of Articles

(71) Applicant: Mario R. Zolud, Van Nuys, CA (US)

(72) Inventor: Mario R. Zolud, Van Nuys, CA (US)

(21) Appl. No.: 13/472,239

(22) Filed: May 15, 2012

(51) Int. Cl. B26D 1/143; B26D 7/26

(52) U.S. Cl. 83/481

(57) ABSTRACT

A slitting apparatus mountable to a web handling apparatus, for slitting a thin web of a first width into plural ribbons each of width less than the first width. The slitting apparatus may comprise at least one enclosed motorized rotatable blade mounted on a rotatable shaft and a stationary base which is screw mountable to the web handling apparatus. The blade is movable between a slitting position for slitting operations and a service position spaced away from the slitting position, for blade replacement. A step-down gearset reduces blade rotational speed from the motor speed. A manual shifting element comprising a manual lever and a cam effects change between the slitting and service positions. The blade may be entirely ceramic or ceramic coated. A roller shaft may be located proximate the blades to maintain tension on the web and to obstruct direct access to the blades for safety purposes.

### FIELD OF THE INVENTION

The present invention relates to severing or slitting an elongated film into plural ribbons each of less width than the original supply, and more particularly, to a motorized slitting apparatus adapted to facilitate replacement of circular slitting blades thereof.

### BACKGROUND OF THE INVENTION

Articles such as packages of beverages must typically be transported for retail distribution on pallets. The beverages may be canned, bottled, or otherwise supplied in containers for use by the ultimate consumer. Cans, bottles, and the like are typically prepared for retail sale by ganging a number of containers together. This may be accomplished by providing a plastic yoke which engages the necks of a predetermined number of individual bottles, such as six bottles, and holds these bottles together as a unit. A number of cans, bottles, or the like, again using the example of six such containers may be held together by shrink wrapping a film about these containers. Regardless of the precise nature of grouped or ganged containers, they must be transported in considerable quantities as they move through distribution channels from a factory to a retail point of sale. Contemporary practice is to load a wooden pallet with the ganged containers stacked on the pallet. Palletized ganged containers may then be efficiently transported using trucks and railway. Fork lifts may be efficiently be used at the point of loading and unloading of palletized containers.

It is an economic and practical necessity that bundling ganged containers onto a pallet be as easily and inexpensively achieved as possible. One solution to this requirement is to wrap or bundle the ganged containers in long strips or ribbons of plastic films. This is widely regarded as a desirable solution since plastic film is strong, inexpensive, easily applied to pallets bearing ganged containers, and easily removed from the pallets.

Plastic films suitable for wrapping ganged containers are available in large rolls, wherein the width of the web of film is much greater than is practical with respect to handling for purposes of wrapping individual pallets and the ganged containers stacked thereon. It then becomes desirable to slit a web of plastic film into two, three or even more distinct ribbons. Each ribbon may be easily applied to one pallet and its ganged containers. When the supply roll of plastic film is slit into a number of ribbons, an equal number of pallets may be prepared for shipment simultaneously. This promotes an economy in that commercial firms which bundle pallets may enjoy minimized costs of the film itself by purchasing a relatively lesser number of relatively large rolls of plastic film, then slitting or cutting these large rolls to desired width in their facilities. Also, the rate of production of prepared pallets may be maximized by the practice of using plural slit ribbon simultaneously in the preparation of an equal number of pallets.

This approach has served the shipping needs of distributors of palletized goods well. However, there remains one aspect of handling films which remains troublesome and relatively expensive. That is, because films are strong and are utilized in very great quantities, the customarily used slitting apparatus experiences fast wear of conventional circular blades which actually slit the film. In some bundling facilities, these blades may require sharpening or more likely replacement on a frequent basis, for example on the order of once a day. Blade replacement entails two types of expenses. One is the cost of the blades themselves. Blades are typically circular steel discs having sharp edges. The other cost is that replacement is a labor intensive operation, partially because replacement is frequently needed, but also because each replacement operation requires considerable time.

There exists within the bundling and shipping industry a need for reducing costs of blade renewal in plastic film slitting operations.

### SUMMARY OF THE INVENTION

The present invention addresses the above stated need in two ways. One way is to utilize blades more durable, thereby requiring less frequent servicing. This may be done by utilizing ceramic materials rather than steel or other metallic materials. For example, the blade may be made entirely or partially from a ceramic material. The latter option may include for example coating the cutting surfaces of a blade with a suitable ceramic, such as a glassy material or a metal carbide. The coated blade may be mostly steel, which enables much of the blade to be fabricated from a relatively inexpensive material compared to the hard material used at the cutting surfaces, using conventional and relatively inexpensive fabrication techniques.

Even though utilization of hard materials for cutting surfaces extends the service life of cutting blades in slitting apparatus, it does not address the issue of the time consuming operation of replacing blades. The present invention sets forth improved slitting apparatus which expedites the process of replacing cutting blades. In this improvement, the slitting apparatus is formed with cutting blades and their associated drive elements such as motor, speed reduction gears, and rotatable shaft supporting the cutting blades, and preferably, a housing which encloses these elements, made movable between a deployed position and a service position. In the service position, the blades are more conveniently accessed, thereby greatly reducing the time required to replace the blades. This reduces direct labor to replace blades and also downtime of idled cutting apparatus.

In one implementation of the invention, the slitting apparatus may comprise stationary elements which are mounted to a frame of a machine which handles the unslit and subsequently slit film material, and a relatively movable blade assembly. The stationary elements may include mounting feet and a housing serving as a stationary supporting structure for a cam system which may then displace the movable blade assembly relative to the mounting feet. The movable blade assembly is moved by the cam system between a deployed position enabling slitting operations, and a service position facilitating blade replacement. The cam system may be operated by a manual lever.

It is an object of the invention to expedite and facilitate blade replacement in slitting apparatus having one or more rotatable slitting blades.

Another object of the invention is to employ an uncomplicated manual system to move the blade assembly between deployed and service positions.

A further object of the invention is to extend the service life of slitting blades.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic, environmental perspective view of the invention.

FIG. 2 is a diagrammatic perspective view of one of the two principal components of the novel slitting apparatus.

FIG. 3 is an exploded perspective view of the two principal components of the novel slitting apparatus.

FIG. 4 is a side view of the camshaft seen at the right of FIG. 3.

FIG. 5 is a side detail view taken along line 5-5 of FIG. 3.

FIG. 6 is a side detail view similar to FIG. 5, but depicted movable components shifted from their original positions shown in FIG. 6.

FIG. 7 is a perspective detail view of a component seen in end view in FIG. 8.

FIG. 8 is an end view of the novel slitting apparatus of FIG. 3.

### DETAILED DESCRIPTION

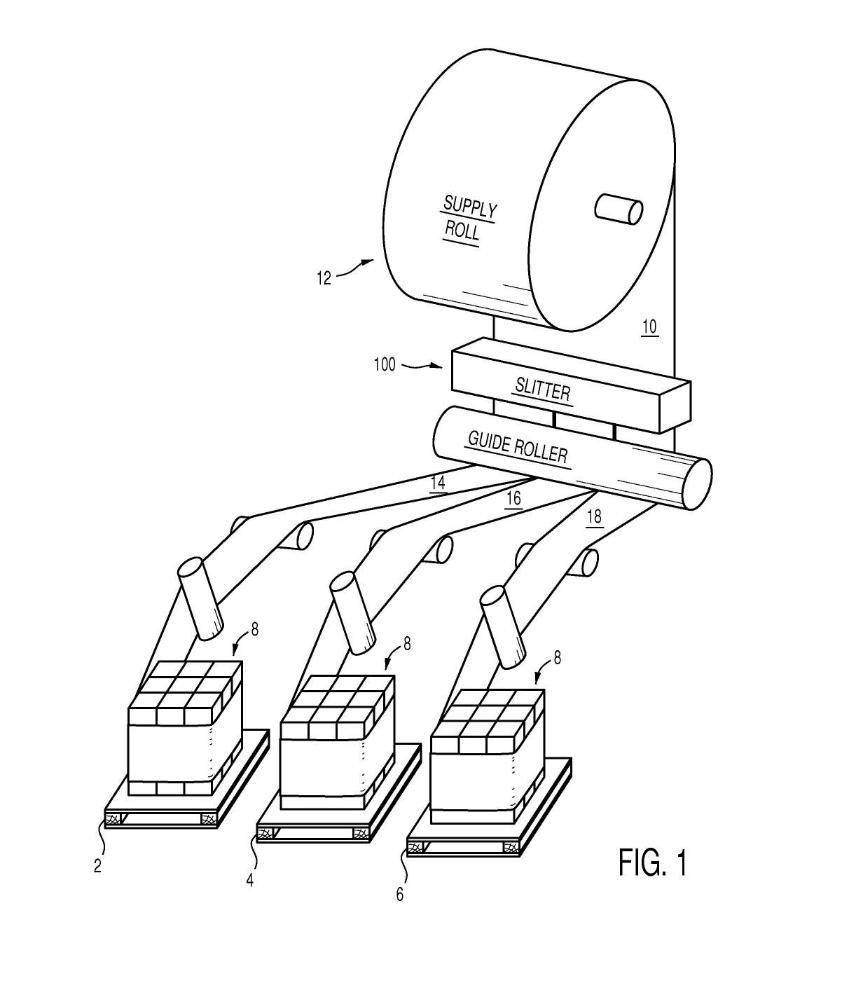

The overall purpose of the invention is diagrammatically illustrated in FIG. 1, wherein three pallets 2, 4, 6 each stacked with goods 8 are in the process of being wrapped or bundled so that each pallet 2, 4, or 6 and its associated goods 8 will be capable of being maneuvered and transported as a unit. Wrapping uses a thin web such as a plastic film 10 which is stored on a large supply roll 12. Plastic film 10 is unreeled from the supply roll 12, moved past a slitting apparatus 100 which slits the plastic film 10 into three separate ribbons 14, 16, 18. Each ribbon 14, 16, or 18 is of width less than the width of the plastic film 10, and is used to wrap one pallet 2, 4, or 6.

Because FIG. 1 is diagrammatic or symbolically representational, the apparatus shown therein is not literally rendered. Also, some necessary conventional apparatus is omitted from FIG. 1. FIG. 1 is only intended to place the novel slitting apparatus 100 into understandable context for the reader. The slitting apparatus 100 is solidly mounted to a solid member of the plastic film handling apparatus (not shown) which is used to store and dispense the plastic film 10, and is oriented to slit the plastic film 10 along its length as the plastic film 10 passes by the slitting apparatus 100. An example of plastic film handling apparatus with which the slitting apparatus 100 may be used is KHS Innopack Kisters SP Basic Shrink Packer, KHS Filing and Packaging, KHS GmbH Juchostr. 20 D-44143 Dortmund, Germany.

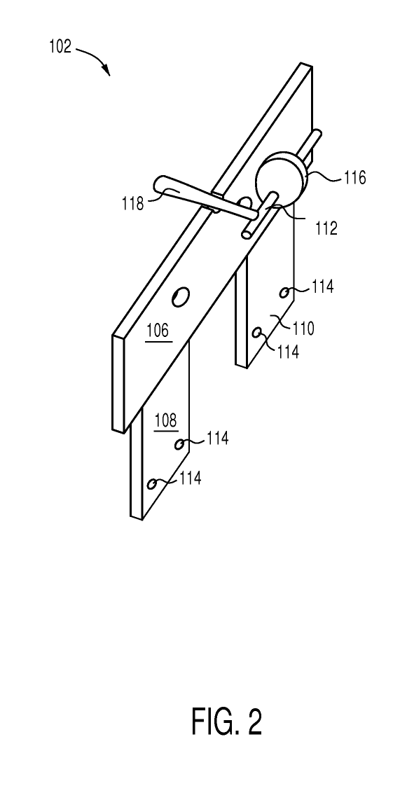

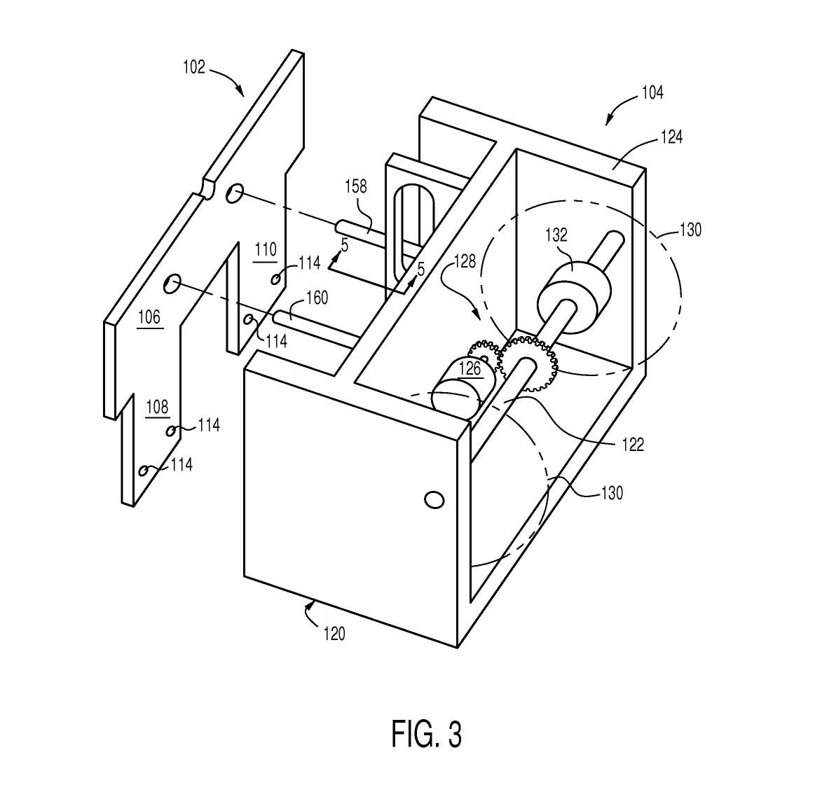

Referring now to FIGS. 2 and 3, the slitting apparatus 100 comprises two principal mutually movable members. One of these members is a stationary base member 102 (FIG. 2), so called because it is solidly fixed such as by bolting to the plastic film handling apparatus. The other member is a blade assembly 104 (FIG. 3) which is movable between a deployed or slitting position, further explained hereinafter, in which the blades of the blade assembly contact and slit passing plastic film 10, and a retracted or service position, which is selected when renewing or otherwise servicing the blades. The stationary member 102 has two functions. One is to provide structural support to the blade assembly 104 so that the blade assembly 104 may be securely mounted on the plastic film handling apparatus. The other is to provide motive elements to move the blade assembly 104 between the slitting position and the service position.

The base member 102 need not be of significant depth. Illustratively, it may comprise a structural panel or web 106, two depending mounting feet 108, 110, and sufficient structure such as trunnion bearing elements (not shown) to rotatably support a camshaft 112 on the structural web 106. The camshaft 112 bears a cam lobe 116 and a lever 118 which serves as a handle for rotating the camshaft 112. As will be explained hereinafter, the camshaft 112 is actuated by the lever to effect movement of the blade assembly 104 between the slitting position and the service position.

Design of the base member 102 depends upon the type of plastic film handling apparatus in use, proximity and orientation of a suitable rugged surface to which the mounting feet 108, 110 may be bolted or otherwise fastened, and is adapted thereto. The mounting feet 108, 110 may have bolt holes 114 through which mounting bolts (not shown) may be passed when mounting the base member 102 to the plastic film handling apparatus.

Referring specifically to FIG. 3, the blade assembly 104 may comprise a blade housing 120 which both encloses and supports moving parts of the blade assembly 104. These moving parts may include a blade shaft 122 which may be journaled in an end wall 124 of the blade housing, or alternatively, held by trunnion bearings (not shown) or rotatably supported within the blade housing 120 in any other suitable way. The blade shaft 122 may comprise a blade retaining element for securing a removable blade to the blade shaft 122 (details of mounting of a blade will be described hereinafter). An electric motor 126 is disposed to rotate the blade shaft 122. Preferably, the electric motor 126 is an AC motor operable on an AC supply circuit, and comprises a step-down gearset 128 which is interposed between the electric motor 126 and the blade shaft 122 and is disposed to rotate the blade shaft 122 at a rotation speed lower than that of the AC motor 126. The slitting apparatus 100 will be understood to include necessary electric circuitry (not shown) necessary to operate the AC motor 126.

The blade housing 120 is incompletely depicted in that an upper wall which closes the interior of the blade housing 120 from above as seen in FIG. 3 and a front wall which partially closes the interior of the blade housing 120 from the front are omitted in the view of FIG. 3. Preferably, the omitted walls would be provided to enclose the AC motor 126, the step-down gearset 128, and the blade shaft 122, sufficiently to prevent direct manual contact with the AC motor 126 and the step-down gearset 128 from outside the blade housing 120. The blades must necessarily be exposed in order to be able to engage and slit the plastic film 10 as the latter passes by the former. The outer circumference of the blades is indicated by broken lines 130 in FIG. 3.

Although not fully visible in FIG. 3, a plurality of blades may be removably mounted to the blade shaft 122. In the embodiment illustrated herein, two blades spaced apart from one another along the blade shaft 122 are provided, which enables the slitting apparatus 100 to slit the plastic film 10 into three separate ribbons 14, 16, 18, as seen in FIG. 1. To this end, the blade shaft 122 comprises blade retaining elements in numbers corresponding to the number of blades intended to be used. Of course, the slitting apparatus 100 may be provided with a greater number of blade retaining elements than blades in active service, if desired (this option is not shown).

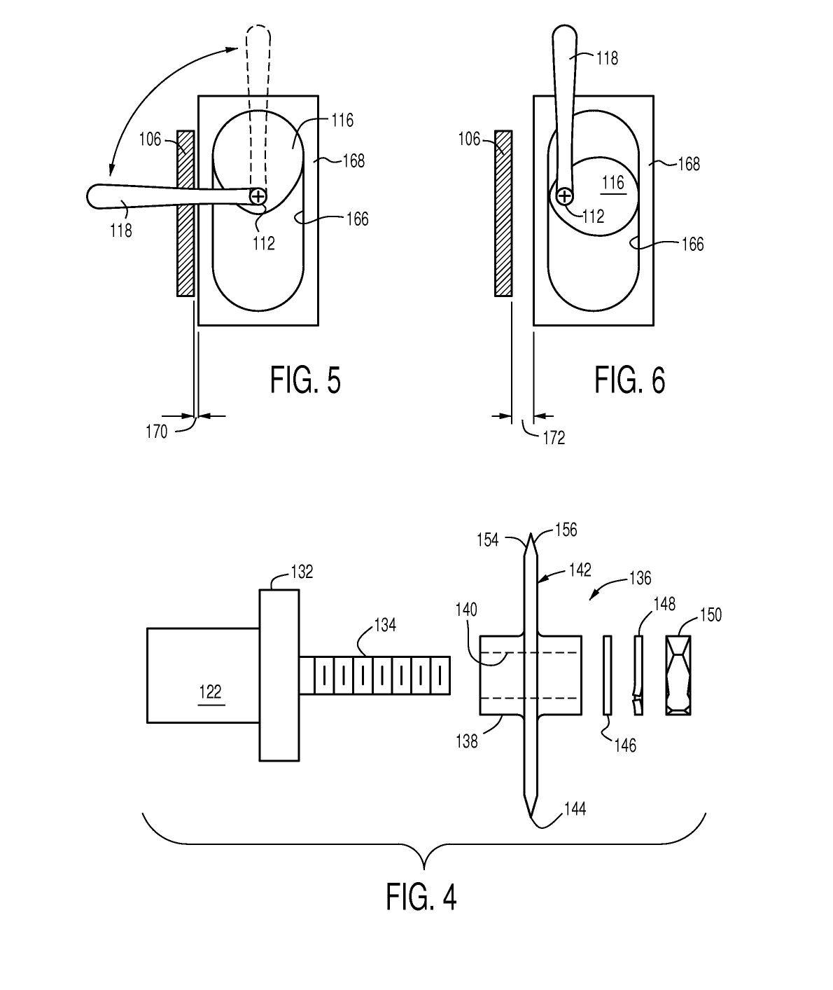

Referring momentarily to FIG. 4, the nature of the blades and the blade retaining elements will be described. The blade shaft 122 at each end may terminate in a circular flange 132 and a threaded stub 134. A blade 136 comprising a hub 138 through which passes a central hole 140 and from which projects a circular disc 142 having a sharp circumferential edge 144 may be slipped over the threaded stub 134. Preferably, the central hole 140 is of dimensions and configuration enabling the stub 134 of the blade shaft 122 to be passed through the central hole 140 in close cooperation therewith. Thus mounted on the blade shaft 122, the blade 136 may be secured in place with suitable fasteners, such as a flat washer 146, a lock washer 148, and a nut 150. Of course, other arrangements may be used, such as a stub of the same diameter as the rest of the blade shaft, bearing a threaded hole for receiving a bolt in place of the nut 150 (this option is not shown).

Although the entire blade 136 may be fabricated entirely from ceramic materials, it may also be fabricated from a less expensive material such as steel, provided that the cutting surface 152 is fabricated from a ceramic material. Ceramic materials may include silica, metal oxides, silicon carbide, a metallic carbide such as tungsten carbide or titanium carbide, or other known hard materials such as cubic boron nitride, polycrystalline diamond, and others, or any combination of these. At a minimum, the point or edge 144 and nearby surfaces 154, 156 will be coated with the ceramic material.

As has been mentioned previously, the blade assembly 104 is movable between a slitting position and a service position. The base member 102 cooperates with the blade assembly 104 to achieve this transition. The blade assembly 104 may comprise two smooth walled fingers 158, 160 which may be received within corresponding holes 162, 164 formed in the web 106 of the base member 102. The holes 162, 164 constrain the blade assembly to move only axially with respect to the fingers 158, 160 and the holes 162, 164, these components thus serving as guide and support elements for holding the blade assembly 104 selectively in the slitting position and the service position. In the slitting position, the blade 136 mounted to the blade shaft 122 projects from the blade housing 120 sufficiently to slit a web passing thereby, as seen in FIG. 3. In the service position, the blade assembly 104 is displaced relative to the stationary base member 120 from the slitting position, wherein the guide and support elements are disposed to constrain the blade assembly 104 to occupy only the slitting position and the service position and to move therebetween.

It will be appreciated that the guide and support elements constrain the blade assembly 104 to the path of travel described above, but do not themselves actually move the blade assembly 104 between the slitting and service positions. The blade assembly 104 is moved between the slitting and service positions by the camshaft 112 and cam lobe 116 when the lever 118 is manually moved.

This is illustrated in FIGS. 5 and 6. FIG. 5 illustrates the service position and first and second positions of the lever 118, which positions correspond to the service position (FIG. 5) and the slitting position (FIG. 6) of the blade assembly 104. The lever 118 has been moved such that cam lobe 116 causes the blade assembly 104 to be drawn relatively near the web 106. Proximity of the blade assembly 104 to the web 106 is indicated by a gap 170. The cam lobe 116 engages the inner surface of an elongated opening 166 of a member serving as a yoke 168 fixed solidly to the housing 120 of the blade assembly 104. When the lever 118 is moved to the position shown in FIG. 6, the cam lobe 116 acts on the yoke 168 to move the blade assembly 104 further from the web 106 than as seen in FIG. 5. This displacement of the blade assembly 104 is apparent from the magnitude of the gap 172 seen in FIG. 6.

The camshaft 112, its associated handle 118 and cam lobe 116, and the yoke 168 may be regarded as a manual shifting element disposed to move the blade assembly 104 between the slitting position and the service position.

It should be noted that the lever 118 is sufficiently long so as to project from the slitting apparatus 100 sufficiently to be exposed to manual access even should the slitting apparatus 100 be provided with a housing (not shown) which fully encloses the components of the base member 102 other than the lever 118.

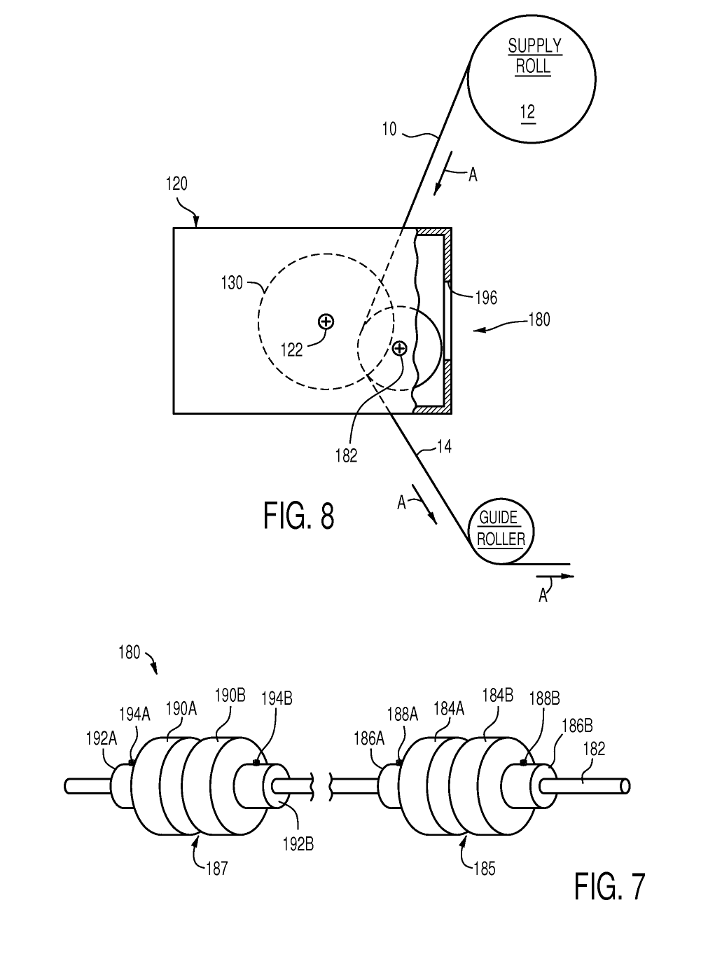

FIG. 7 shows a tension roller assembly 180 which may be provided to assure that the web 10 is under appropriate tension as it contacts the blades, the latter represented as circumference 130 (see FIG. 3). The tension roller assembly 180 may also provide a safety function, as further described hereinafter. The tension roller assembly 180 may comprise a tension shaft 182 which may be supported for example by being journaled within holes formed in the end walls such as the end wall 124 of the blade housing 120. A pair of circular bearings 184A, 184B are rotatably mounted for free rotation on the tension shaft 180, and if not constrained, may move axially along the tension shaft 180. During assembly of the slitting apparatus 100, the pair of circular bearings 184A, 184B are moved axially along the tension shaft 182 into sandwiching relationship about one blade represented by the blade circumference 130, and are locked into place leaving a gap 185 for receiving the blade. Spacing of the circular bearings 184A, 184B to the blade is fairly close, but sufficiently spaced apart so as to enable unimpeded rotation of the blade. One pair of circular bearings 184A, 184B is provided for each blade. Each pair of circular bearings such as the pair of circular bearings 184A, 184B is surrounded by a pair of stops such as stops 186A, 186B. Each stop may comprise a disc which is movable axially along the tension shaft 182 and may have a setscrew such as the setscrews 188A, 188B, which when tightened locks its associated disc to the tension shaft 182. This maintains the circular bearings 184A, 184B in a selected position surrounding their associated blade which is received in close proximity thereto within a gap 187.

FIG. 7 depicts a second set of circular bearings 190A, 190B and stops 192A, 192B each having a setscrew 194A or 194B, each of which may be the structural and functional equivalent of their similarly named counterparts described above.

FIG. 8 illustrates the function of the tension roller assembly 180, which is mounted to the blade housing 120 in any suitable way, such as journaling as mentioned above. It will be seen that the blade housing 120 may have an access opening 196 which opens the blade housing 120, thereby exposing the blades to access. The tension roller assembly 180 may be disposed proximate the blade shaft 122. The tension roller assembly 180 may be located between the cutting blades and the access opening 196, thereby obstructing the blades to direct access through the access opening 196.

It will be seen that the web 10 is maintained under tension even as it passes by the blades (again, represented by blade circumference 130). This holds the web 10 in an optimum position as the web 10 moves in the direction of the arrows A so that cutting effort imposed on the blades is minimized.

Thus the tension roller assembly 180 serves not only to hold the web 10 in an appropriate and effective position for slitting, but also provides a measure of safety in obstructing direct access to the blades.

Although described as journaled within the blade housing 1240, the tension roller assembly 180 could be supported on a bracket (not shown), and further, the bracket may be adjustable in position so as to adjust tension imposed on the web 10.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

1. A slitting apparatus mountable to a web handling apparatus, for slitting a thin web of a first width into plural ribbons each of width less than the first width, comprising:
a blade assembly comprising a blade housing, a blade shaft which is rotatably mounted within the blade housing and which comprises a blade retaining element for securing a removable blade to the blade shaft;
a stationary base member which is attachable to the web handling apparatus, comprising at least one mounting foot for engaging the web handling apparatus, a guide and support element for holding the blade assembly selectively in a slitting position wherein a removable blade mounted to the blade shaft projects from the blade housing sufficiently to slit a web passing thereby, and a service position wherein the blade assembly is displaced relative to the stationary base member from the slitting position, wherein the guide and support element is disposed to constrain the blade assembly to occupy only the slitting position and the service position and to move therebetween; and
a manual shifting element disposed to move the blade assembly between the slitting position and the service position.

2. The slitting apparatus of claim 1, wherein the manual shifting element comprises a lever which is exposed to manual access, which is movable between a first position and a second position, and which is disposed to move the blade assembly between the slitting position and the service position when the lever is manually moved between the first position and the second position.

3. The slitting apparatus of claim 2, wherein the manual shifting element comprises a cam which is actuated by the lever and which effects movement of the blade assembly between the slitting position and the service position.

4. The slitting apparatus of claim 1, wherein the blade assembly comprises an electric motor disposed to rotate the blade shaft.

5. The slitting apparatus of claim 4, wherein the electric motor is an AC motor operable on an AC supply circuit, and wherein the blade assembly comprises a step-down gearset interposed between the electric motor and the blade shaft, wherein the step-down gearset rotates the blade shaft at a rotation speed lower than that of the AC motor.

6. The slitting apparatus of claim 1, wherein the blade housing encloses the AC motor, the step-down gearset, and the blade shaft, and prevents direct manual contact with the AC motor and the step-down gearset from outside the blade housing.

7. (canceled)

8. (canceled)

9. (canceled)

10. (canceled)

11. (canceled)
